(19) United States
(12) Patent Application Publication
(10) Pub. No.: US 2019/0014741 A1
(43) Pub. Date: Jan. 17, 2019

(54) System for monitoring feeding behavior of each individual animal in a group-housed cage

(71) Applicant: Yogendra Bhakta Shrestha, Germantown, MD (US)

(72) Inventor: Yogendra Bhakta Shrestha, Germantown, MD (US)

(73) Assignee: MOUSE WORKS, Germantown, MD (US)

(21) Appl. No.: 16/036,901

(22) Filed: Jul. 16, 2018

Related U.S. Application Data
(60) Provisional application No. 62/533,102, filed on Jul. 16, 2017.

(51) Int. Cl. A01K 1/03; A01K 5/01; G01G 19/414; G01G 19/415

(52) U.S. Cl. CPC A01K 1/031; G01G 19/415; G01G 19/4146; A01K 5/0114

(57) ABSTRACT

The objective of the present invention is to provide a system capable of efficiently and accurately monitoring each individual animal in a group-housed cage with high temporal resolution. Multiple food containers are used in a feeding unit to allow multiple animals to feed freely and simultaneously. Each food container is incorporated with an electronic weight measuring component to continuously monitor the change in food weight in each food container. An electronic RFID tag detector/reader is incorporated at the food accessing opening of each container to identify the animal accessing the food container.

### REFERENCE TO RELATED APPLICATIONS

The present application relates and claims priority to U.S. provisional patent application No. 62/533,102, filed on Jul. 16, 2017.

### BACKGROUND OF THE INVENTION

### Field of the Invention

The present invention relates to the field of systems for monitoring feeding behavior in laboratory animals. More particularly, the present invention relates to the field of systems for monitoring feeding behavior of individual animals that are housed in a group in a cage environment.

### Motivation and Description of Related Art

Food intake studies in laboratory animals are widely used in a variety of biological research. Methods to monitor laboratory animal feeding behavior are important to all biological researchers, especially to nutritionists, and researchers studying obesity, diabetes, eating disorder, energy metabolism, endocrinology, etc. The common method used for measuring food intake of laboratory animals is to firstly, separate individual animal from its social group such as its littermates, that are housed together in a cage, and house it alone in a new single cage. Secondly, provide weighed food pellets into the food hopper and manually weigh the food pellets remained in the hopper at specified time points over the course of the study ranging from days to weeks by either laboratory staff or animal facility technician. Food intake for an animal is calculated by the difference in the initial weight of the food pellets and the food weight at the specified time points. This approach is both labor-intensive and inaccurate. Labor-intensive because an experimenter has to prepare individual cage with food, water, and bedding for each individual animal and repeat this for all animals included in the study, and subsequently weigh and record weight of the food pellets at the start and at different time points of the study that the experimenter is interested in looking at. Inaccurate because separation of individual animal in single cages devoids them from their natural setting or their social group which in and of itself is known to affect feeding behavior probably by causing stress, thus obscuring the outcome of the experiment. The purpose of a feeding behavioral study is to understand the feeding behavior of these animals in their natural habitat or setting which in this case is the social group the mice are housed together in since weaning or from birth. In addition, repeated human access to the cage to weigh food periodically can significantly disturb the animal's feeding behavior. Due to these limitations, the manual method is neither efficient nor accurate for studying the feeding behavior of laboratory animals. Furthermore, this method fails miserably when experiments aimed at studying higher temporal resolution of the feeding behavior is necessary.

Automated food intake monitoring systems have been developed for laboratory animals. In these systems, food containers are incorporated with electronic weight measuring devices and the weight of the food in the container is measured and recorded, periodically. These weighings can be made conveniently and without disturbing the animals. However, these systems can only be used in experimental designs where only a single animal can access a food container, requiring the laboratory animals to be placed in solitary cages. This represents a departure in the animal behavior from normal, which constitutes group housing in one cage, and that can fundamentally affect their feeding behavior.

Therefore, it is desirable to develop a system capable of efficiently and accurately monitoring each individual animal in a group-housed cage with high temporal resolution.

### SUMMARY OF THE INVENTION

The objective of the present invention to provide a system capable of efficiently and accurately monitoring each individual animal in a group-housed cage with high temporal resolution.

One aspect of the present invention is the use of multiple food containers in a feeding unit. Each food container has a food accessing opening that allows access to a single laboratory animal at a time. Therefore, multiple animals can access food simultaneously and freely at different food containers without interrupting one another. This is important for experimental settings where the laboratory animals live in a group environment.

Another aspect of the present invention is that the weight of each food container in a feeding unit can be monitored independently, automatically, and continuously. An electronic weight measuring component is incorporated with each food container to track the change in the food weight in that container. The weighing data can be collected and recorded throughout the duration of the experiment.

Another aspect of the present invention is the capability to identify the individual animal accessing a specific food container. This is achieved by first attaching an electronic RFID tag to the head region, for example, one of the ears of the animal. The electronic RFID ear tag contains information such as the animal id number. An electronic RFID tag detector/reader is incorporated at the food accessing opening of the food container. When the animal is accessing food through the food access opening, the electronic tag detector/reader detects and reads the electronic id of that animal.

By combining the above aspects, the present invention provides a system capable of continuously monitoring feeding behavior of multiple laboratory animals housed in a group in a cage. The above invention aspects will be made clear in the drawings and detailed description of the invention.

### BRIEF DESCRIPTION OF THE DRAWINGS

FIG. 1 is an exploded view of an embodiment of applying a feeder unit in an animal cage in the present invention.

FIG. 2 is an exploded view of the embodiment of the feeder unit in the present invention.

FIG. 3 is an illustration of the embodiment of the RFID ear tag and the exploded views of the left side, top-right, and the bottom-left of the embodiments of the RFID ear tag applicator, including the embodiment of the RFID ear tag placed in position in the RFID ear tag applicator in the present invention.

FIG. 4 is a block diagram of the base sensing unit for a single feeder pocket.

FIG. 5 is a block diagram of the quad reporting unit for four (4) feeding units in a cage.

FIG. 6 is a block diagram of a process to collect data from multiple quad reporting units.

FIG. 7 is a block diagram of another process to collect data from multiple quad reporting units.

### REFERENCE NUMERALS IN THE DRAWINGS

Reference is now made to the following components of embodiments of the present invention:
010 Animal cage
020 Cage cover
030 Water container
040 Water bottle
100 Feeding unit
110 Feeder pocket
112 Guard bar
114 Pocket lift handle
120 Side panel of the feeder unit
122 Front wall
124 Back wall
126 Food access opening
128 RFID Coil Antenna retainer
130 Load cell platform
135 Load cell
140 Antenna
180 Feeder unit lift handle
190 Protecting container
200 RFID Ear tag
210 Electronic RFID capsule
220 Ear tag staple
300 Base sensing unit
310 Analog-to-digital converter (ADC) for load cell
320 RFID reader
330 Sensing unit
340 Clock
400 Quad sensing unit
410 Quad reporter
510 Collector
600 RFID eartag applicator
601 Handle
602 Tag holder
603 Base
604 Ear clamp
605 Shaft
606 Shaft hole of handle
607 Shaft hole of platform base
608a Spring housing of platform base
608b Spring housing at bottom of tag holder
609a Spring housing at top of tag holder
609b Spring housing of handle
610 Thumb rest
611 Slot for RFID eartag
612 Anvil
613 Hammerhead
614 Conical spring

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described and claimed herein.

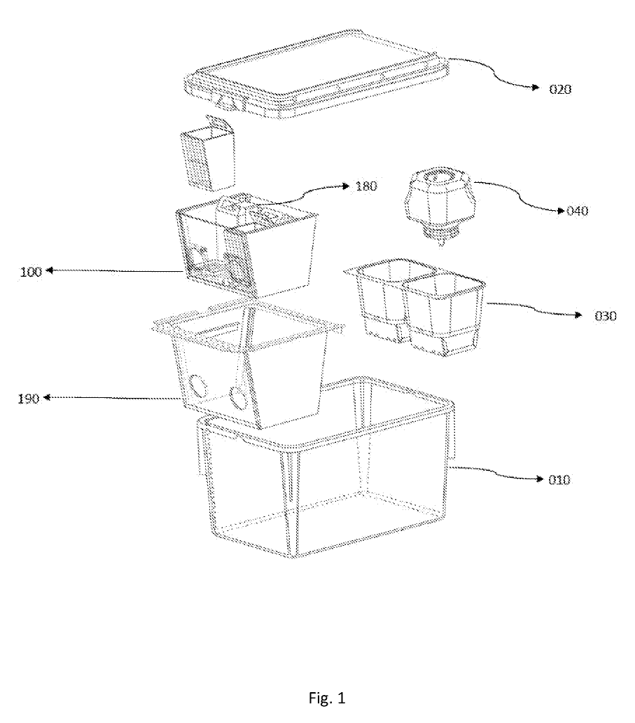

FIG. 1 shows an example of a using a feeding unit in the present invention. The feeding unit 100 is to be placed in a laboratory animal cage 010 and can be accessed by multiple animals at the same time. The feeding unit fits into a matching protecting container 190. A lift handle 180 is fastened to the top of the feeding unit 100 to provide convenience in carrying the feeding unit 100 and moving it in and out the protecting container 190. The feeding unit 100 records food consumption by each animal accessing each of the units. In addition to the feeding unit 100, the animal cage 010 is further equipped other necessities such as a cover 020, water containers 030 and a water bottle 040.

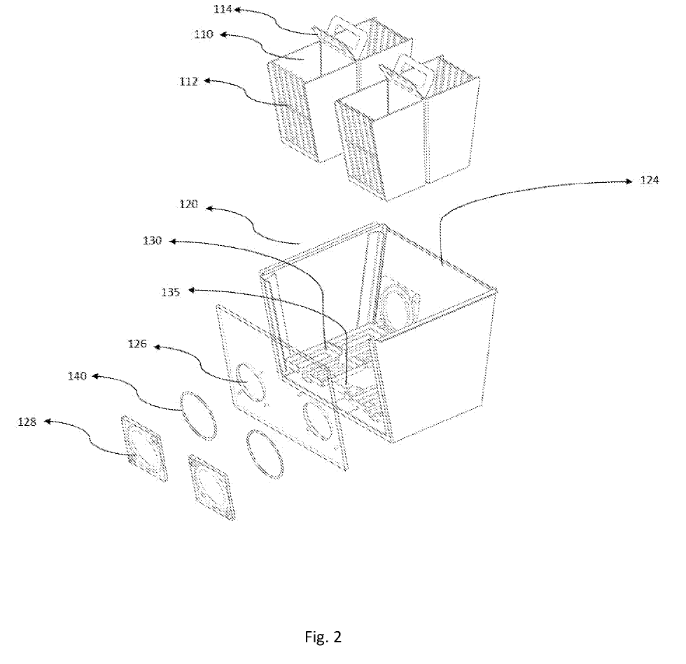

The construction components of the feeding unit 100 are illustrated by the exploded view in FIG. 2. In this embodiment, the feeding unit comprises 4 independent feeder pockets 110. Each feeder pocket 110 is a food container opened at the top for loading food. Each feeder pocket 110 also comprises at least one side opening for an animal to access food. The feeder pocket 110 may comprise guard bars 112 at the front opening and a pocket lift handle 114 at the top. The feeder pockets 110 are placed in a load cell platform 130 and each feeder pocket 110 rests on top of a load cell platform 130. The load cell 135 sitting under the load cell platform 130 is a transducer which creates an electrical signal whose magnitude is directly proportional to the weight of the feeder pocket 110 placed on top of the load cell platform 130. The electrical signal is transmitted to a control and/or recording component (not shown in this figure) to track the weight of each feeder pocket 110. Therefore, the amount of food left in each feeder pocket 110 can be tracked continuously. The feeding unit 110 comprises two opposite side walls 120, a front wall 122 and a back wall 124. Preferably, the front wall 122 and back wall 124 are made of a transparent or semi-transparent material so the amount of food left in the feeder pocket 110 can be conveniently visualized from either side of the load cell pocket. The front wall 122 and back wall 124 comprises food access openings 128, each opening corresponding to one feeder pocket 110. The size and shape of the food access openings 128 are designed to allow a single animal to access food at each opening 128 at a time.

An antenna 140 is placed at each food access opening 126 and secured in place by an antenna retainer 128. The antenna 140 can detect the presence and signature of an electronic tag, such as radio-frequency identification (RFID). The information received by the antenna 140 is also transmitted to the control and/or recording component of the system. Each animal participating in a feeding behavior is monitored using an electronic RFID tag, preferably secured to an ear. The electronic RFID tag contains information such as the animal id number. When the animal is accessing food at the food access opening 128, the antenna 140 detects and reads the electronic id of that animal. Each of the feeder unit load cell is paired with its feeding access located RFID reader 140, therefore there are four pairs of load cells and an RFID readers in the feeding unit and each pair is located in the same feeder unit 110 as shown in FIG. 2. Every time an animal accesses the opening, the RFID reader 140 detects the RFID eartag on the animal and its paired load cell detects and records the weight of the feeder pocket. These two detections are paired and recorded simultaneously along with a date and time stamp. The RFID reader detects the RFID eartag as long as it is inside the reading range of the reader 140. Therefore, the duration of each of the accessing event of the individual animal in any of the feeder pockets is detected and recorded. When the RFID eartag moves away from the RFID reader's reading range any change in the weight of the feeder unit 110 for that RFID tag event (that is from the first detection to its un-detection for that event) is considered as one bout (or event) of the feeding behavior.

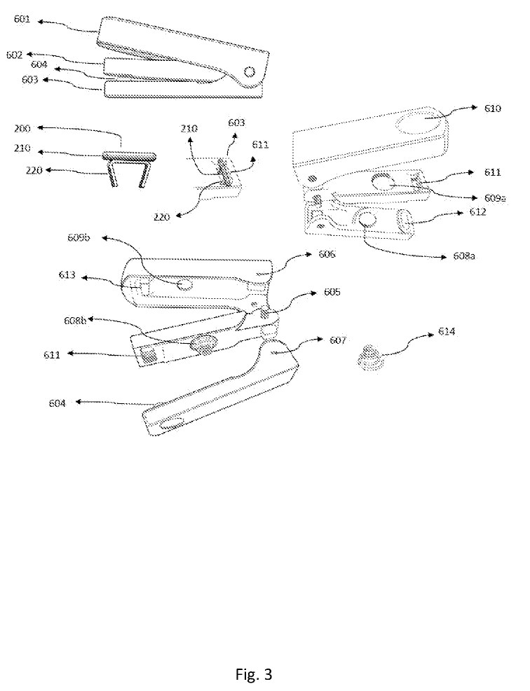

FIG. 3 shows an embodiment of an animal RFID ear tag 200 used in the feeding behavior monitoring system. The RFID ear tag 200 comprises a capsule 210 that contains an electronic RFID chip (not shown in this figure) that can be read by the antennas 140 in the feeding unit 100. The capsule 210 is attached to a tag staple 220 and embedded in epoxy resin to bond the capsule to the staple firmly (not shown in the figure) so that it can be stapled on one of the animal's ears. The epoxy coating can be made of different colors which will assist investigators from identifying visually one color ear tagged animal from another. This feature can be useful when there are multiple groups of mice in an experiment or study allowing for visual identification of one group of animal, with one color ear tag, from another, with different color ear tag and so on. The animal RFID eartag 200 can be made small enough to be attached to small laboratory animals, such as rodents. When an animal is accessing food at one of the food access openings 128 in the feeding unit 100, the animal RFID ear tag 200 attached to one of the animals ears enters the detection range of the antenna 140, and the animal's identity information is read and transmitted to the control and/or recording component of the system.

The RFID applicator 600 as shown in the FIG. 3 is designed to assist in applying the RFID eartag 200 onto animal ears in efficient and secured manner both for the user and for the animal.

The applicator is assembled from three main components including a handle 601, a tag holder 602, and a base 603 as shown in FIG. 3. These three components are held together at one end of their lengths through holes 606 of the handle and 607 of the base with a cylindrical metal shaft that forms a hinge around which each part is allowed to move as shown in FIG. 3. There are two conical springs 614 located in between each of the three components, i.e. between housings 608(a) and 608(b), and 609a and 609b, respectively, as shown in FIG. 3.

Detailed description on the mechanism of how the RFID ear tag is applied onto the ears of animals by the applicator is as follows. The RFID ear tag is placed in the slot 611 of the tag holder 602 with the staples facing down towards the anvil 612 as shown in FIG. 3. The animal ear is slid in between the tag holder 602 and base 603. Around the anvil 612 of the base 603 protrudes a half circle raised rim called ear clamp 604, as shown in FIG. 3 which creates a space between the ear and the anvil 612. As the applicator is pressed the hammer head 613 pushes the tag staple through the animal ear onto the anvil 612 causing the staples to bend on themselves. Because of the space between the ear and the anvil created by the ear clamp 604, the staple bends outside of the animal ear, thus creating a clamp effect of the RFID ear tag on animal ear. After the ear tag is stapled pressure is released on the handle and the base, and simultaneously the springs 614 in between the handle, tag holder, and the base pushback these components to their original positions for next round of RFID ear tag application.

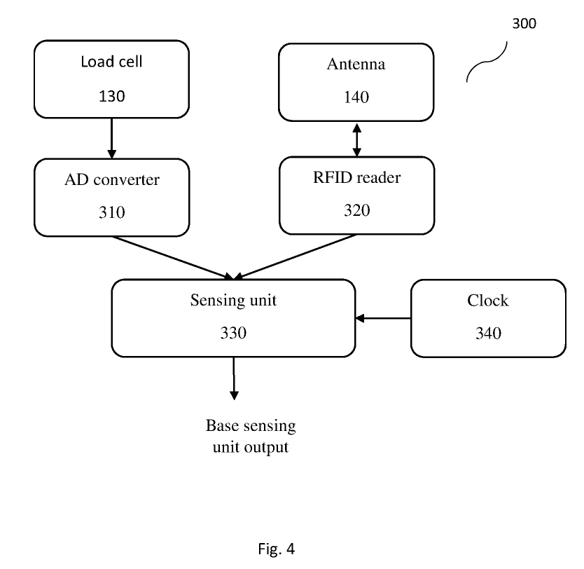

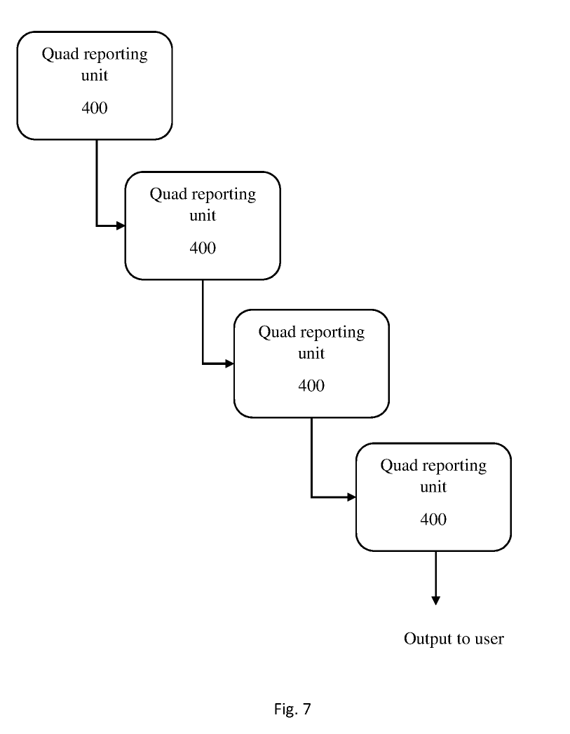

The electronic and software control of the feed consumption monitoring system is outlined in the diagrams in FIGS. 4-7. FIG. 4 shows the control chart of a base sensing unit 300 for one feeder pocket 110. The load cell sitting under the load cell platform 130 weighing the feeder pocket 110 is connected to an analog-to digital converter (ADC) 310 to convert the load cell voltage to a digital signal corresponding to the weight of the feeder pocket 110. The output digital weight signal is fed to a sensing unit 330. The signal detected by the antenna 140 is converted by an RFID reader circuit 320 and the RFID information is also sent to the sensing unit 330. A system clock 340 is used to provide time-stamp and synchronization. When the RFID reader 140 detects an RFID within its range, it reads the id information of the animal. Its paired load cell measures the weight of the feeder pocket. These two detections are paired and recorded simultaneously along with a date and time stamp. Therefore, the duration of each of the accessing event of the individual animal is detected and recorded. When the RFID ear tag moves away from the RFID reader's reading range any change in the weight of the feeder unit 110 for that RFID tag event is considered as one bout (or event) of the feeding behavior.

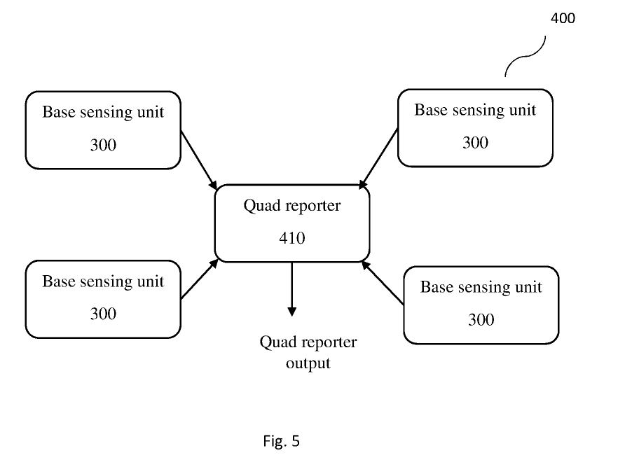

FIG. 5 shows the control chart of a quad sensing unit 400 for a feeding unit 100 with 4 feeder pockets 110. The output signal from each base unit 300 is collected by a quad reporter 410 firmware and an output is generated to report feed consumption status of the feeding unit 100 including each of its feeder units.

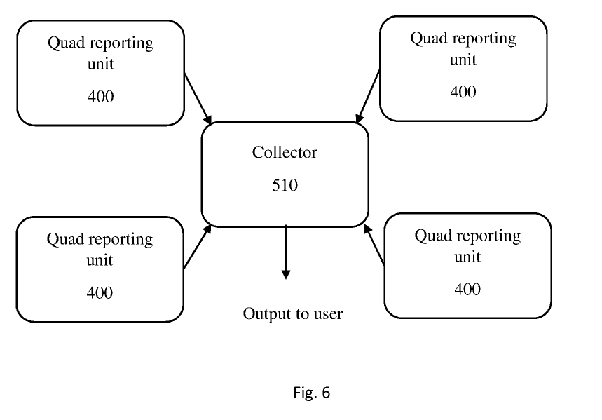

Quad reporter output from multiple quad sensing units 400 can be collected in various ways. For example, the output data can be collected by a common collector 510, as shown in FIG. 6. Alternatively, since the quad reporters 410 already have means to receive and communicate data, the data collection process can use a “daisy chain” scheme where each quad reporting unit 400 passes data to the next quad reporting unit 400 until the information chain has passed through all quad reporting units and the complete set of data is sent to output. The daisy chain scheme can support a large number of sensing units without requiring a separate collector firmware.

The foregoing description and accompanying drawings illustrate the principles, preferred or example embodiments, and modes of assembly and operation, of the invention, however, the invention is not, and shall not be construed as being exclusive or limited to the specific or particular embodiments set forth hereinabove. For example, the firmware architecture can be implemented to report from six or eight or more pairs of sensors (a pair consists of an RFID reader and a load cell) from a single cage, greater than the four pairs of sensors that the quad reporters report from a cage as claimed in this invention. In other examples, similar tracking strategies can be applied to liquid consumption, where the water containers are equipped with the load cells and RFID detectors. Other variations and applications will be understood and practiced by those skilled in the art.

What is claimed is:

1. A system and method for monitoring a plurality of animals in a group-housed cage, comprising:
a plurality of food containers, each food container accessible by at least one of the animals via a food accessing opening;
a plurality of electronic weight measuring devices, each weight measuring device configured to continuously monitor the change in food weight in one of the food containers; and
a plurality of RFID tag detectors, each RFID tag detector incorporated at the food accessing opening of one of the food container to identify the animal accessing the food container.
